(19) United States
(12) Patent Application Publication
(10) Pub. No.: US 2013/0226403 A1
(43) Pub. Date: Aug. 29, 2013

(54) SETTING METHOD, A SENSOR AND A SENSOR SETTER FOR A TIRE PRESSURE MONITORING SYSTEM IN A MOTOR VEHICLE

(71) Applicant: Hangzhou Hamaton Tyre Valves Co., Ltd, (US)

(72) Inventor: Jianer ZHANG, Hangzhou (CN)

(73) Assignee: Hangzhou Hamaton Tyre Valves Co., Ltd, Hangzhou (CN)

(21) Appl. No.: 13/777,681

(22) Filed: Feb. 26, 2013

(30) Foreign Application Priority Data
Feb. 28, 2012 (CN) 201210047055.9

(51) Int. Cl. G01M 17/02

(52) U.S. Cl. CPC G01M 17/02
USPC 701/36; 701/34.4

(57) ABSTRACT

A method for setting a sensor for a tire pressure monitoring system in a motor vehicle, includes storing a plurality of encoding procedures is stored the sensor. By sending instructions to the sensor by the setter, all other encoding procedures except the required encoding procedures from a plurality of encoding procedures stored in advance in the sensor are processed, neither able to be encoded nor to be invoked for encoding. Furthermore, during application, data encoded by an encoding procedure is required to be sent out, thus not only solving the problem characterized by large data processing and large power consumption, but also preventing the sensor from being counterfeited by lawbreakers easily.

### FIELD OF THE INVENTION

The invention relates to a tire pressure monitoring system (TPMS) in a motor vehicle, in particular to a sensor for a tire pressure monitoring system in a motor vehicle, and a setting method and a setter thereof.

### BACKGROUND OF THE INVENTION

TPMS is shorted for Tire Pressure Monitoring System, comprising a sensor arranged in a tire and a receiving and processing unit arranged in a motor vehicle, used for monitoring data (for example, pressure and temperature etc) related to the tire, and informing a driver for a timely handling in the form of sound and image (text description) in the event of abnormal change of data related to the tire. TPMS is based on the operating principle that data related to the tire is subject to acquisition and processing by the sensor, the processed data is then sent by wireless means in a special data format to the receiving and processing unit in the motor vehicle, and then the receiving and processing unit decodes the data received and displays relevant information.

Since its appearance in 2000, TPMS has been subject to upgrade and improvement for many times. At present, the most popular TPMS consists of four sensors and a receiving processor, referred to as a direct-type TPMS, in which, a TPMS sensor is a critical component in the TPMS. The battery-powered TPMS sensor can be generally used 5-7 years. Therefore, it is necessary to replace it with a new TPMS sensor after a certain time. At present, there are 6-7 suppliers in the world supplying TPMS for the original motor vehicle manufacturer. Since 2000, TPMS has been subject to continuous design and update and developed into 60-70 different types. Each sensor has different data formats for sending signals. The major problem is different sensors are non-interchangeable, and a certain sensor may be only used in a certain type of motor vehicle. Therefore, an auto repair shop may store many different types of sensors for different types of vehicles waiting for maintenance in future. Thus, it is inconvenient for both the auto repair shop and final consumers. Furthermore, it is inconvenient to replace a damaged sensor or a battery-exhausted sensor.

For the above-mentioned problems, there is a solution in the past, namely, a plurality of encoding procedures is installed in a sensor in advance. When in use, the above-mentioned encoding procedures encode data acquired in sequence, and the sensor sends the data immediately once it is encoded until the data format is correct. The solution can reduce trouble for the auto repair shop. However, the sensor has a great deal of data to be processed, and the above-mentioned steps must be repeated every time when the motor vehicle is restarted, which causes large power consumption, also the sensor has higher requirements for its hardware configuration but shorter service life.

For the above-mentioned problems, there is another solution in the past, namely, no encoding procedure is stored in a sensor, and an auto repair shop is equipped with a sensor setter. When an auto needs repairing in the auto repair shop, the setter selects an encoding procedure and sends it to the sensor on the spot. This solution not only solves the above-mentioned problems but also eliminates disadvantages of the previous solution. However, the sensor may be easily imitated by lawbreakers, thus causing loss of the owner's rights and interests.

### SUMMARY OF THE INVENTION

One technical problem that the invention aims at solving is to provide a method for setting a sensor for a tire pressure monitoring system in a motor vehicle, which not only can solve the problem puzzling auto repair shops, but also can avoid disadvantages of the above-mentioned background art. For this purpose, the invention adopts the technical scheme described below.

According to one aspect of the invention a method includes providing the sensor in which a plurality of encoding procedures is stored in advance;

The method also includes a step for providing a sensor setter in which encoding procedure processing instruction sent to the sensor is stored, sending encoding procedure processing instruction to the sensor by wireless or wired means by the setter once or more than once, and the sensor receiving the encoding procedure processing instruction, on the basis of which, all other encoding procedures except the required encoding procedure processing instruction are processed once for all or processed one by one, in this way, the processed encoding procedures are subject to deletion or failure of encoding or failure of invoking for encoding.

Further, the encoding procedure processing instruction is a program deletion instruction, or a program modification instruction or an encoding procedure selection instruction.

Further, the setter sends the encoding procedure processing instruction integrally to the sensor by multiple match codes, namely by the way of sending program bytes.

Further, an encoding procedure lock-in instruction is stored in the setter, and the method also includes, before or after or at the same time of sending the encoding procedure processing instruction, the setter sends the encoding procedure lock-in instruction to the sensor by wireless or wired means, after receiving the encoding procedure lock-in instruction and before processing other encoding procedures except the required encoding procedure, the sensor locks the required encoding procedure, in this way, it is impossible to delete or modify the required encoding procedure.

Alternatively, the method also includes wherein the sensor locks the required encoding procedure by responding to an induction signal, in this way, it is impossible to delete or modify the required encoding procedure.

Another technical problem that the invention aims at solving is to provide a sensor for a tire pressure monitoring system in a motor vehicle for realization of the above-mentioned method. For this purpose, the invention adopts the following technical scheme.

A sensor for a tire pressure monitoring system in a motor vehicle includes a data processing unit, an electrically erasable memory cell, a sensor unit, at least comprising a pressure sensor, and a data transmission unit, wherein the data processing unit is internally provided with an electrically erasable encoding procedure memory module in which a plurality of encoding procedures are stored wherein the data processing unit is also provided with an encoding procedure processing module which is used for processing unwanted encoding procedures in the encoding procedure memory module on the basis of encoding procedure processing instruction, in this way, the unwanted encoding procedures are subject to deletion or failure of encoding or failure of invoking for encoding, and wherein the unwanted encoding procedures are encoding procedures except the required encoding procedures.

Further, the data processing unit is also internally provided with an encoding procedure lock-in module which is used for, on the basis of the encoding procedure lock-in instruction or the responsive induction signal, locking the required encoding procedures so that it is impossible to delete or modify the required encoding procedures.

Further, the data transmission unit comprises a wireless data transmission module or a wired data transmission module additionally.

Another technical problem that the invention aims at solving is to provide a sensor setter for a tire pressure monitoring system in a motor vehicle for realization of the above-mentioned method. For this purpose, the invention adopts the following technical scheme.

The sensor setter for a tire pressure monitoring system in a motor vehicle includes a data processing unit, a data input unit, and a data transmission unit, wherein the setter is provided with an encoding procedure processing instruction memory module for invoking the data processing unit, the encoding procedure processing instruction is stored in the encoding procedure processing instruction memory module and wherein the data transmission unit, on the basis of the instruction from the data processing unit, outward transmits the encoding procedure processing instruction stored in the encoding procedure processing instruction memory module.

Further, the setter is provided with an encoding procedure lock-in instruction memory module for invoking the data processing unit, the encoding procedure lock-in instruction is stored in the encoding procedure lock-in instruction memory module; the data transmission unit, on the basis of the instruction from the data processing unit, outward transmits the encoding procedure lock-in instruction stored in the encoding procedure lock-in instruction memory module.

Further, the data transmission unit comprises a wireless data transmission module or a wired data transmission module additionally.

Due to adoption of the technical scheme, a plurality of optional encoding procedures is stored in advance in the sensor provided by the invention. Only data encoded by the encoding procedure is required to be emitted when the sensor is applied to tire pressure measurement for a motor vehicle, thus not only solving the problem characterized by large data processing and large power consumption, but also preventing the sensor from being counterfeited by lawbreakers easily. The sensor is suitable for the method for setting a sensor for a tire pressure monitoring system in a motor vehicle provided by the invention.

Due to adoption of the technical scheme, the setter provided by the invention is suitable for the method for setting a sensor for a tire pressure monitoring system in a motor vehicle provided by the invention. Only data encoded by the encoding procedure is required to be emitted when the sensor is set for application, thus not only solving the problem characterized by large data processing and large power consumption, but also preventing the sensor from being counterfeited by lawbreakers easily.

Due to adoption of the technical scheme, by virtue of the method provided by the invention, the sensor is provided with a plurality of optional encoding procedures. Only data encoded by the encoding procedure is required to be emitted when the sensor is set for application, thus not only solving the problem characterized by large data processing and large power consumption, but also preventing the sensor from being counterfeited by lawbreakers easily.

### BRIEF DESCRIPTION OF THE DRAWINGS

FIG. 1 is a schematic diagram of the sensor and the setter in the embodiment of the invention;

FIG. 2 is a flow diagram showing the sensor for encoding procedure processing and locking in the embodiment of the invention; and

FIG. 3 is a flow diagram showing the setter for transmitting the encoding procedure processing instruction and lock-in instruction in the embodiment of the invention.

### DETAILED DESCRIPTION OF THE EMBODIMENTS

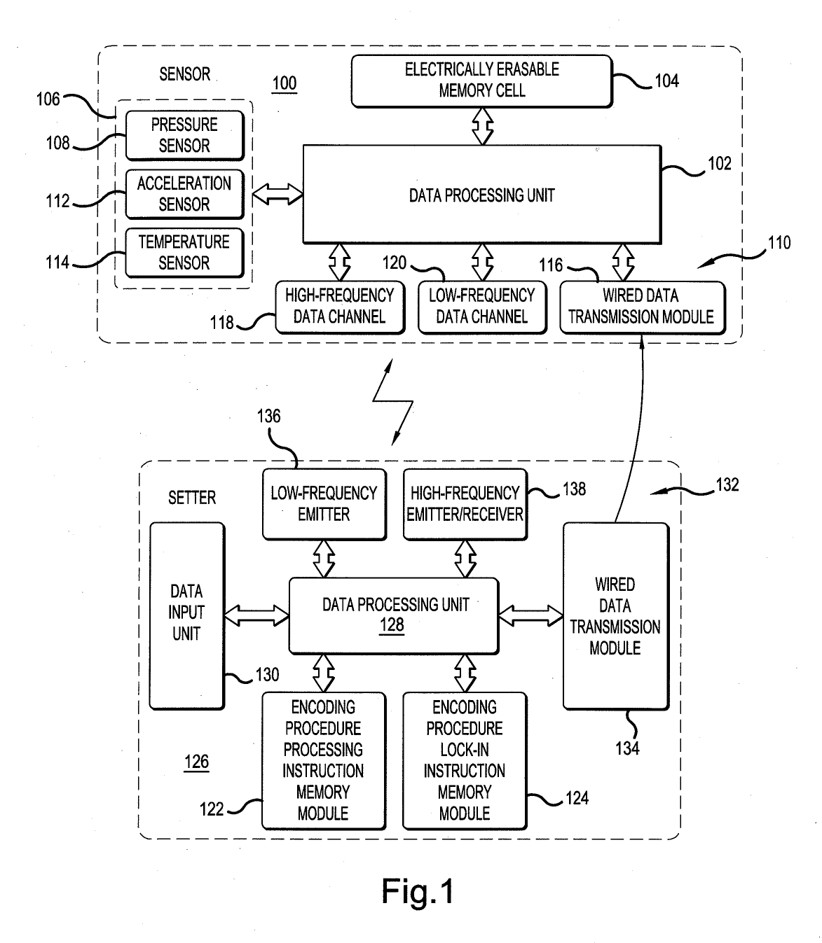

By reference to FIG. 1, the sensor for a tire pressure monitoring system in a motor vehicle is internally provided with a data processing unit 102, an electrically erasable memory cell 104, a sensor unit 106, at least comprising a pressure sensor 108, and a data transmission unit 110.

The data processing unit is internally provided with an electrically erasable encoding procedure memory module in which a plurality of encoding procedures are stored. The data processing unit is also provided with an encoding procedure processing module which is used for, on the basis of encoding procedure processing instruction, processing unwanted encoding procedures in the encoding procedure memory module, in this way, the unwanted encoding procedures are subject to deletion or failure of encoding or failure of invoking for encoding; the unwanted encoding procedures are encoding procedures except the required encoding procedures.

In addition to a pressure sensor 108, the sensor unit 106 can also be provided with a temperature sensor 112, an acceleration sensor 114 and other sensors used for data acquisition. The sensor unit 106 is mainly used for collecting relevant data information and sending it to the data processing unit 102. By using processed remaining encoding procedures, the data processing unit 102 encodes and integrates, on the basis of executed protocol, the data required to be sent, and sends the data integrated to certain data format, by means of the data transmission unit 110, to an ECU in a motor vehicle.

The data transmission unit includes a wireless data transmission module or a wired data transmission module 116 and additionally is mainly used for providing a data transmission carrier for response commands, and meanwhile providing a data path for the response commands. The wireless data transmission module comprises a high-frequency data channel 118 and a low-frequency data channel 120, in which, one is used for receiving data sent from the setter and feedback data sent from the ECU in a motor vehicle, while the other is used for receiving response signal after the setter sending data and for sending data to the ECU in a motor vehicle.

The data processing unit 102 can be a microprocessor which is provided with an electrically erasable encoding procedure memory module and an encoding procedure processing module, and further provided with an encoding procedure lock-in module.

At the phase of sensor setting, on the basis of the encoding procedure processing instruction from the data transmission unit 102, the encoding procedure processing module is used to process those unwanted encoding procedures in the encoding procedure memory module, so that the unwanted encoding procedures in the encoding procedure memory module are subject to deletion or failure of encoding or failure of invoking for encoding. Furthermore, on the basis of the encoding procedure lock-in instruction from the data transmission unit, the encoding procedure lock-in module is used to lock those required encoding procedures, so that the required encoding procedures are impossibly subject to deletion or modification. The lock-in instruction can be either an instruction requiring the sensor to lock the required encoding procedures or a signal indicating that the setter completely sends the encoding procedure processing instruction, on the basis of which, the encoding procedure lock-in module locks the required encoding procedures.

At run phase, responding to induction signal from the sensor unit, remaining required encoding procedures not processed by the encoding procedure processing module are used after the setting phase in the encoding procedure memory module to process signal information from the sensor unit and other data required to be sent, and to send the processed data to the data transmission unit.

The electrically erasable memory cell can store data collected by the pressure sensor unit and other sensor units.

The encoding procedure processing instruction can be an instruction to process one or one group of encoding procedure selected, namely, at the setting phase, the sensor receives a plurality of encoding procedure processing instructions for respective requirement for processing different encoding procedures, in this way, the encoding procedure processing module processes the encoding procedures one by one until only those required encoding procedures remained. The encoding procedure processing instructions also aim at all other encoding procedures except those required encoding procedures, in this way, the encoding procedure processing module processes all unwanted the encoding procedures at one time, with only required encoding procedures left.

The encoding procedure processing instruction can be a program deletion instruction, or a program modification instruction or an encoding procedure selection instruction, in which, the method for modification as for the program modification instruction includes but not limited to: modulation mode, data width, bit wide, function code, pressure range, checkout, data head code and data algorithm, etc. After the data processing unit responds to the relevant instruction, encoding procedures in the encoding procedure module arae subject to modification according to the above-mentioned methods, so that the encoding procedures are impossible for encoding or invoking for encoding. As for the encoding procedure selection instruction, when the sensor receives the instruction, the encoding procedure processing module of the sensor processes those encoding procedures selected by the encoding procedure processing module from encoding procedure selection instruction and those encoding procedure except these selected encoding procedures.

Referring again to FIG. 1, the sensor setter 126 for a tire pressure monitoring system in a motor vehicle includes a data processing unit 128, a data input unit 130, and a data transmission unit 132.

The setter is provided with an encoding procedure processing instruction memory module 122 for invoking the data processing unit. The data transmission unit 132, on the basis of instruction from the data processing unit, outward transmits the encoding procedure processing instruction stored in the encoding procedure processing instruction memory module 122.

Further, the setter 126 is provided with an encoding procedure lock-in instruction memory module 124 for invoking the data processing unit. The data transmission unit, on the basis of instruction from the data processing unit, outward transmits the encoding procedure lock-in instruction stored in the encoding procedure lock-in instruction memory module.

The data processing unit can be a microprocessor which is mainly used for generating different instructions according to different needs, for sending the instructions to the sensor by virtue of the data transmission unit and meanwhile receiving feedback signal sent from the sensor.

The data input unit 130 is used for establishing a bridge for intercommunication between the data processing unit and outer computers, for convenience of updating the programs in the encoding procedure processing instruction memory module, the programs in the encoding procedure lock-in instruction memory module, and other programs run by the setter.

The data transmission unit 132 comprising a wireless data transmission module or a wired data transmission module 134 and additionally is mainly used for establishing a bridge for data communication between the setter and the sensor. The wireless data transmission module includes a low-frequency emitter 136 used for sending the encoding procedure lock-in instruction and other instructions to the sensor, and a high-frequency emitter/receiver 138 used for sending feedback signal to the sensor and receiving feedback signal from the sensor.

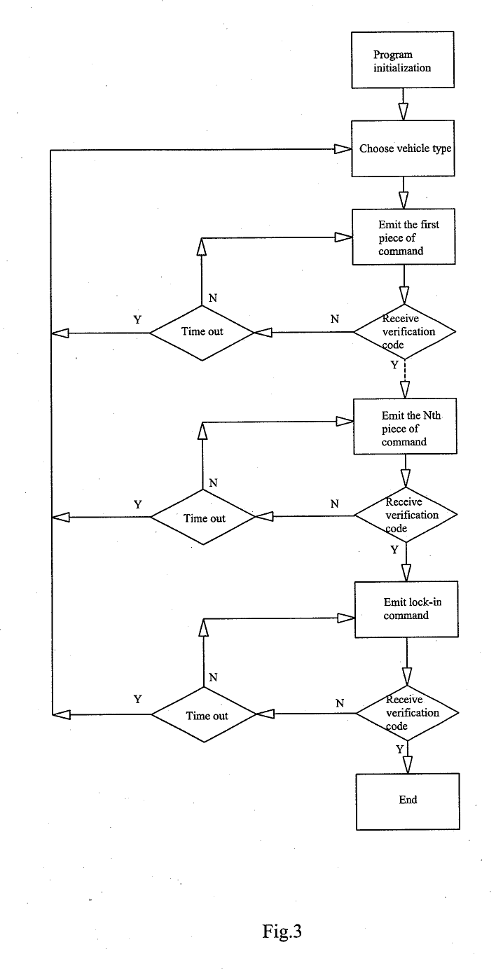

A method for setting a sensor for a tire pressure monitoring system in a motor vehicle includes providing the sensor in which a plurality of encoding procedures is stored in advance, and providing a sensor setter in which encoding procedure processing instruction sent to the sensor is stored. The encoding procedure processing instruction is a program deletion instruction, or a program modification instruction or an encoding procedure selection instruction. The method also includes sending the encoding procedure processing instruction to the sensor by wireless or wired means by the setter once or more than once In the embodiment, the setter sends the encoding procedure processing instruction integrally to the sensor by multiple match codes, just as shown in FIG. 3.

1-1. Users, on the basis of motorcycle type, choose applicable encoding procedure processing instructions.

1-2. The data transmission unit, on the basis of instructions from the data processing unit, sends a piece of encoding procedure processing instruction.

1-3. The setter waits for security code signal fed back from the sensor.

The above-mentioned steps shall be continued to be repeated in case of validity of verification until an integral encoding procedure processing instruction is sent out. However, the above-mentioned steps shall be restarted in case of invalidity of verification.

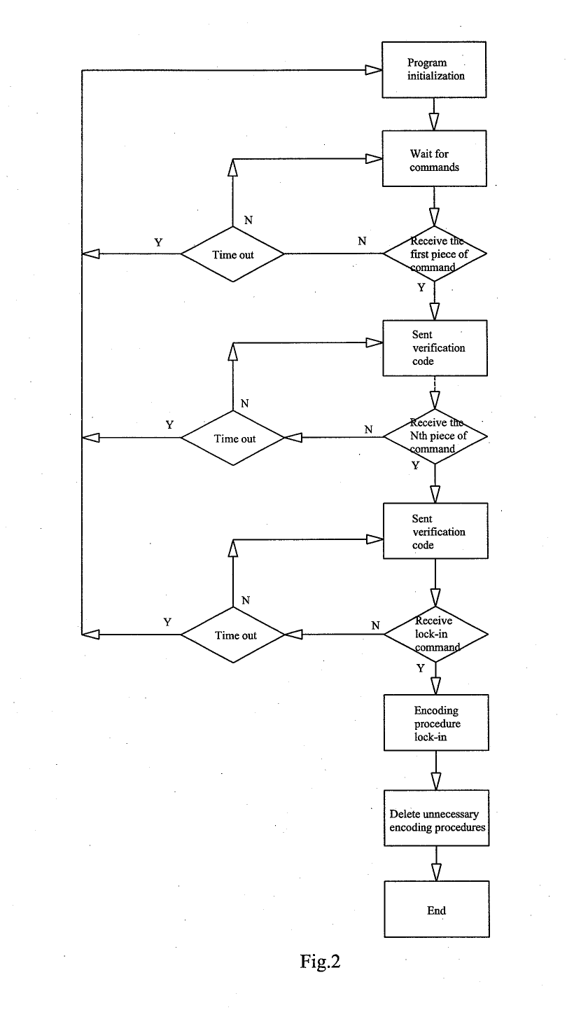

Furthermore, in the method the sensor receives the encoding procedure processing instruction, on the basis of which, all other encoding procedures except the required encoding procedure processing instruction are processed once for all or processed one by one, in this way, the processed encoding procedures are subject to deletion or failure of encoding or failure of invoking for encoding. Please refer to FIG. 2, specifically as follows:

2-1 The sensor waits for the encoding procedure processing instruction sent from the setter.

2-2. After receiving information sent from the setter, the sensor feeds back signal.

2-3. The data processing unit of the sensor carries out verification, the next step is started if the encoding procedure processing instruction is sent correctly or integrally; otherwise, the information is fed back to the setter.

The above-mentioned steps shall be repeated until integral encoding procedure processing instruction is received.

2-4. The data processing unit of the sensor, on the basis of the encoding procedure processing instruction, processes the encoding procedures, in this way, the unwanted encoding procedures are subject to deletion or failure of encoding or failure of invoking for encoding.

An encoding procedure lock-in instruction is stored in the setter The method also includes, before or after or at the same time of sending the encoding procedure processing instruction, the setter sending the encoding procedure lock-in instruction to the sensor by wireless or wired means. As is illustrated in FIG. 3, after the final piece of the encoding procedure processing instruction is sent, the data transmission unit of the setter, on the basis of instruction from the data processing unit of the sensor, sends the encoding procedure lock-in instruction.

Referring to FIG. 2, after receiving the encoding procedure lock-in instruction and before processing other encoding procedures except the required encoding procedure, the sensor locks the required encoding procedure, in this way, it is impossible to delete or modify the required encoding procedure.

Before the sensor is installed in the tire or before the tire rolls, the above-mentioned lock-in steps are carried out according to instruction or signal from the setter as required. During implementation, the sensor can also be automatic subject to encoding procedure lock-in on the basis of external induction signal. For example, after the tire rolls, the data processing unit of the sensor responds to external induction signal such as acceleration and pressure signals etc., after which, the encoding procedure lock-in module automatically executes encoding procedure lock-in, specific steps are seen as below:

1. The data processing unit of the sensor receives signal sent from the acceleration sensor for response of tire rotation.

2. The data processing unit of the sensor responds to the signal sent from the acceleration sensor for response of tire rotation and invokes the encoding procedure lock-in module to lock the required encoding procedures, in this way, it is impossible to delete or modify the required encoding procedure.

What is claimed is:

1. A method for setting a sensor for a tire pressure monitoring system in a motor vehicle, the method comprising:
providing the sensor in which a plurality of encoding procedures is stored in advance;
providing a sensor setter in which encoding procedure processing instruction sent to the sensor is stored;
sending encoding procedure processing instruction to the sensor by wireless or wired means by the setter once or more than once; and
the sensor receiving the encoding procedure processing instruction, on the basis of which, all other encoding procedures except the required encoding procedure are processed once for all or processed one by one, in this way, the processed encoding procedures are subject to deletion or failure of encoding or failure of invoking for encoding.

2. The method for setting a sensor for a tire pressure monitoring system in a motor vehicle according to claim 1, wherein the encoding procedure processing instruction is a program deletion instruction, or a program modification instruction or an encoding procedure selection instruction.

3. The method for setting a sensor for a tire pressure monitoring system in a motor vehicle according to claim 1, wherein the setter sends the encoding procedure processing instruction integrally to the sensor by multiple match codes, namely by the way of sending a piece of program bytes.

4. The method for setting a sensor for a tire pressure monitoring system in a motor vehicle according to claim 1, wherein an encoding procedure lock-in instruction is stored in the setter, and
wherein the method further comprises:
before or after or at the same time of sending the encoding procedure processing instruction, the setter sends the encoding procedure lock-in instruction to the sensor by wireless or wired means;
after receiving the encoding procedure lock-in instruction and before processing other encoding procedures except the required encoding procedure, the sensor locks the required encoding procedure.

5. A sensor for a tire pressure monitoring system in a motor vehicle, comprising:
a data processing unit;
an electrically erasable memory cell;
a sensor unit, at least comprising a pressure sensor; and
a data transmission unit,
wherein the data processing unit is internally provided with an electrically erasable encoding procedure memory module in which a plurality of encoding procedures are stored, wherein the data processing unit is also provided with an encoding procedure processing module which is used for processing unwanted encoding procedures in the encoding procedure memory module on the basis of encoding procedure processing instruction such that the unwanted encoding procedures are subject to deletion or failure of encoding or failure of invoking for encoding, and
wherein the unwanted encoding procedures are encoding procedures except the required encoding procedures.

6. The sensor for a tire pressure monitoring system in a motor vehicle according to claim 5, wherein the data processing unit is also internally provided with an encoding procedure lock-in module which is used for, on the basis of the encoding procedure lock-in instruction or the responsive induction signal, locking the required encoding procedures so that it is impossible to delete or modify the required encoding procedures.

7. The sensor for a tire pressure monitoring system in a motor vehicle according to claim 5, wherein the data transmission unit comprises a wireless data transmission module or a wired data transmission module additionally.

8. A sensor setter for a tire pressure monitoring system in a motor vehicle, comprising:
a data processing unit;
a data input unit; and
a data transmission unit,
wherein the setter is provided with an encoding procedure processing instruction memory module for invoking the data processing unit, the encoding procedure processing instruction is stored in the encoding procedure processing instruction memory module, and
wherein the data transmission unit, on the basis of the instruction from the data processing unit, outward transmits the encoding procedure processing instruction stored in the encoding procedure processing instruction memory module.

9. The sensor setter for a tire pressure monitoring system in a motor vehicle according to claim 8, wherein the setter is provided with an encoding procedure lock-in instruction memory module for invoking the data processing unit, the encoding procedure lock-in instruction is stored in the encoding procedure lock-in instruction memory module, and
wherein the data transmission unit, on the basis of the instruction from the data processing unit, outward transmits the encoding procedure lock-in instruction stored in the encoding procedure lock-in instruction memory module.

10. The sensor setter for a tire pressure monitoring system in a motor vehicle according to claim 8, wherein the data transmission unit comprises a wireless data transmission module or a wired data transmission module additionally.

11. The method for setting a sensor for a tire pressure monitoring system in a motor vehicle according to claim 1, wherein the sensor locks the required encoding procedure by responding to an induction signal.
